(19) United States
(12) Patent Application Publication
(10) Pub. No.: US 2023/0422045 A1
(43) Pub. Date: Dec. 28, 2023

(54) SPECTRUM SHARING WITHOUT NETWORK SHARING

(71) Applicant: Apple Inc., Cupertino, CA (US)

(72) Inventors: Alexander Sirotkin, Hod Hasharon (IL); Pavan Nuggehalli, San Carlos, CA (US)

(73) Assignee: Apple Inc., Cupertino, CA (US)

(21) Appl. No.: 18/208,830

(22) Filed: Jun. 12, 2023

Related U.S. Application Data
(60) Provisional application No. 63/355,534, filed on Jun. 24, 2022.

(51) Int. Cl. H04W 16/14; H04W 4/12

(52) U.S. Cl. CPC H04W 16/14; H04W 4/12; H04W 92/20

(57) ABSTRACT

Techniques are disclosed for the spectrum sharing without network sharing. One example includes a method implemented for spectrum sharing without network sharing. A first network node can transmit, via a horizontal user plane interface, a first message to a second network node. The message can include a request for shared spectrum. The first network node can be configured to transmit a first network identifier associated with a first operator. The second network node can be configured to transmit a second network identifier associated with a second operator. The first network node can receive, via the horizontal user plane interface, a second message from the second network node. The second message can coordinate shared spectrum access between the first network node and the second network node. The first network node can access the shared spectrum, based on the response.

### BACKGROUND

Cellular communications can be defined in various standards to enable communications between a user equipment and a cellular network. For example, the Fifth generation mobile network (5G) is a wireless standard that aims to improve upon data transmission speed, reliability, availability, and more.

### BRIEF DESCRIPTION OF THE DRAWINGS

FIG. 1 is an illustration of a resource coordination environment, according to one or more embodiments.

FIG. 2 is an illustration of a resource coordination environment in which one network node is operated by a non-3GPP entity, according to one or more embodiments.

FIG. 3 is a signaling diagram for a first network node in communication with a second network node for spectrum sharing coordination, according to one or more embodiments.

FIG. 4 is a signaling diagram for a first network node in communication with a second network node for spectrum sharing coordination, according to one or more embodiments.

FIG. 5 is a signaling diagram for a first network node in communication with a second network node for spectrum sharing coordination, according to one or more embodiments.

FIG. 6 is a signaling diagram for a first network node in communication with a second network node for spectrum sharing coordination, according to one or more embodiments.

FIG. 7 is a signaling diagram for a first network node in communication with a second network node for spectrum sharing coordination, according to one or more embodiments.

FIG. 8 is a signaling diagram for a first network node in communication with a second network node for spectrum sharing coordination, according to one or more embodiments.

FIG. 9 is an illustration describing a resource coordination message 902, according to one or more embodiments.

FIG. 10 is an illustration of a resource coordination environment in which a central network node is used for resource coordination, according to one or more embodiments.

FIG. 11 is an illustration of a resource coordination environment in which a central network node is used for resource coordination, according to one or more embodiments.

FIG. 12 is a process flow for spectrum sharing without network sharing, according to one or more embodiments.

FIG. 13 is a process flow for spectrum sharing without network sharing, according to one or more embodiments.

FIG. 14 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. In order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Spectrum sharing enables multiple users in a close geographic area to share the same spectrum resources for transmitting and receiving communications. As user demand for spectrum increases, service providers can provide spectrum sharing services to satisfy this demand. In some instances, the users that are sharing the spectrum resources belong to different categories of users. Furthermore, these user categories can be tiered classes of users, where different tiers have different levels of access to a network's resources.

One such tiered system is implemented for the Citizen's Broadband Radio Service (CBRS), which is a network architecture defined by WINNF-TS-0016. In one example, the CBRS includes a spectrum from 150 MHz in the 3550 MHz to 3700 MHz range shared by three tiers of users. The first tier includes incumbent access users, who are grandfathered users, such as fixed satellite services. The second tier includes priority access licensees (PAL), who are users that have acquired a portion of the frequency band through a competitive bidding process. The third tier includes general authorized access (GAA) users, who are users that can use frequencies not previously assigned to one of the higher tier users (e.g., incumbent and PAL). As described herein, tiers are not limited to CBRS tiers, as multiple cellular networks across the globe have implemented tiered systems, such a licensed shared access model. Rather the above is illustrative of a tiered system in which higher tier-level users have greater access to network users than lower-tier users.

Embodiments of the present disclosure are described in connection with fifth generation (5G) networks. However, the embodiments are not limited as such and similarly apply to other types of communication networks, including other types of cellular networks such as fourth generation long term evolution (4G LTE) networks and sixth generation (6G) networks.

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “base station” as used herein refers to a device with radio communication capabilities that is a network component of a communications network (or, more briefly, a network) and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein refers to a communications network that includes a set of network nodes configured to provide communications functions to a plurality of user equipment via one or more base stations. For instance, the network can be a public land mobile network (PLMN) that implements one or more communication technologies, including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element” as used herein refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, or 5G NR. In general, 3GPP access refers to various types of cellular access technologies.

The term “Non-3GPP Access” refers to any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted”: Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types of non-cellular access technologies.

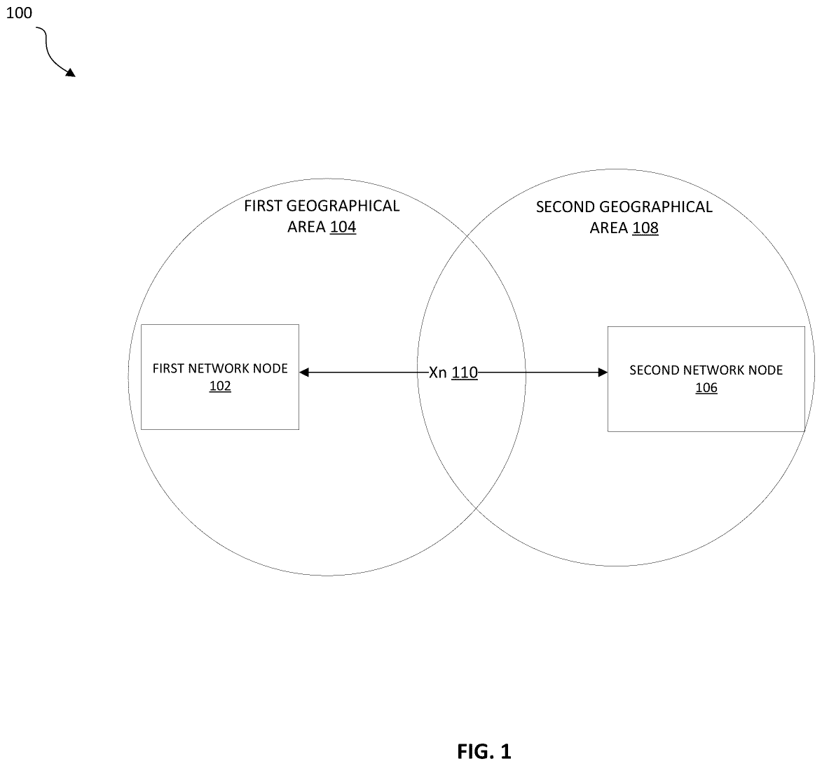

FIG. 1 is an illustration of a resource coordination environment 100, according to one or more embodiments. A first network node 102 can provide a first cell over a first geographical area 104. The first network node 102 can be a neighbor to a second network node 106. The second network node 106 can provide a second cell over a second geographical area 108 that fully or partially overlaps the first geographical area 104 such that the first network node 102 and the second network node 106 cover a common area. As described herein, the first network node 102 and the second network node 106 can include various network nodes and various technical standards, such as a 4G eNB, a 5G gNB, a 6G base station, or a non-3GPP wireless node (e.g., radar or satellite, etc.).

The network node 102 and the second network node 106 can operate under a spectrum sharing framework to coordinate the use of shared spectrum between different operators. In some instances, each operator can belong to the same tier. In some other instances, these operators can belong to different tiers. In scenarios in which the operators belong to different tiers, the operators can be granted access to the network's shared spectrum based on their tier. The sharing framework can outline the access guarantees that each operator can expect based on their tier from the network. The sharing framework can also provide terms such as a geographic area that the operators can use the network's resources, how long the operators can use the networks resources, and a cost associated with using the network's resources. Regardless of tier, the first network node 102 can be configured to transmit a first network identifier associated with a first operator. The second network node 106 can be configured to transmit a second network identifier associated with a second operator. In some embodiments, the first network identifier can be a first public land mobile network (PLMN) identifier associated with a first operator. The second network identifier can be a second PLMN associated with a second operator.

From time to time, different operators can each intend to use shared spectrum. Under the current 3GPP network architecture, spectrum sharing between the operators can only be realized with network (radio access network (RAN)) sharing. For example, to realize spectrum sharing, the operators can coordinate the sharing of spectrum via the same RAN element (e.g., base station).

The herein described embodiments are directed towards spectrum sharing between operators in which the spectrum sharing capability is decoupled from the use of a shared RAN element. As described herein, an operator can use spectrum that is shared with another entity. In one scenario, the other entity is another operator that belongs to the same tier as the operator. In another scenario, the other entity belongs to another tier, for example, a higher tier. Therefore, in a sharing scenario, the operator belonging to the incumbent tier has a greater level of access to the shared spectrum than the operator belonging to the lower tier. Furthermore, spectrum sharing can be realized without the operator and the other entity sharing the next generation radio access network (NG-RAN). Rather the operator and the other entity are connected via a network interface for coordination of the spectrum sharing. In some instances, this coordination can be realized via a horizontal interface, such as Xn 110, or similar interface. As used herein, an Xn can be a horizontal user plane interface defined between two NG-RAN nodes. The Xn can provide the delivery of user plane protocol data units (PDUs) between the two NG-RAN nodes.

In other instances, the coordination can be realized via a central node, such as a core network, spectrum access system (SAS), or another network node. The embodiments allow for greater deployment flexibility as the embodiments can be implemented into the existing physical infrastructure. The embodiments further provide a mechanism for managing competition for shred resources between operators. The embodiments are further applicable to the same architecture and protocols to spectrum sharing with non-3GPP technology.

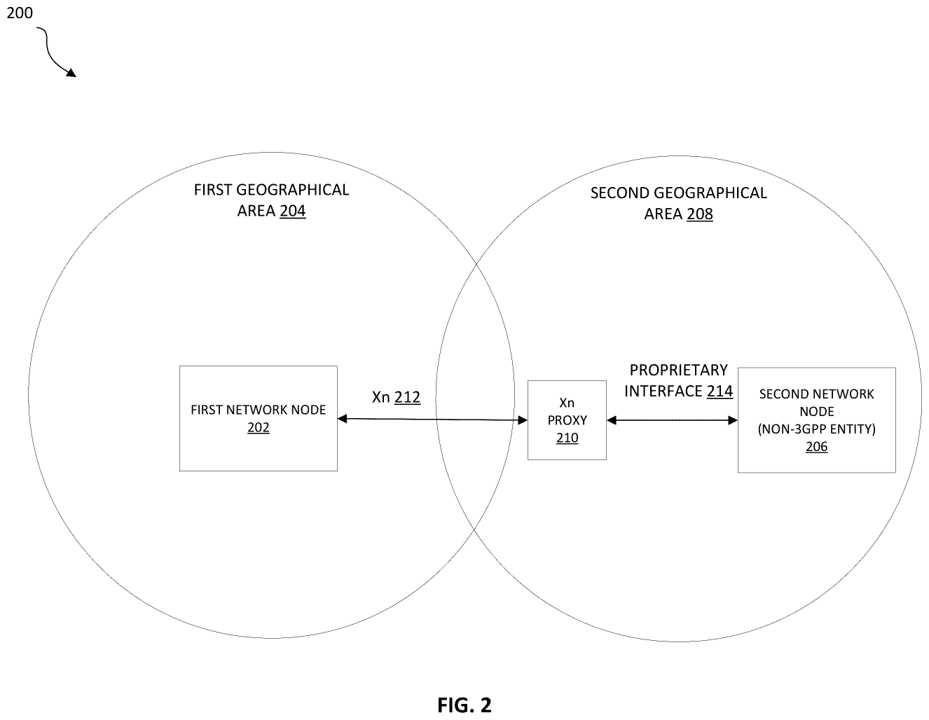

FIG. 2 is an illustration of a resource coordination environment 200 in which one network node is operated by a non-3GPP entity, according to one or more embodiments. A first network node 202 can provide a first cell over a first geographical area 204. The first network node 202 can be a neighbor to a second network node 206. The second network node can be operated by a non-3GPP entity. Therefore, the first network node 202 can communicate with the second network node via an Xn proxy 210 that is in a communication path between the first network node 202 and the second network node 204. The Xn proxy 210 can be hardware, such as a radar, coupled with software to enable communication between the first network node 202 and the second network node 206. The first network node 202 can communicate with the Xn proxy 210 via Xn 212 or a similar interface. The Xn proxy 210 can receive the communication and translate it to be compatible with the non-3GPP entity. The Xn proxy 210 can transmit the translated communication to the second network node 206 via a proprietary interface 214 of the non-3GPP entity. In some embodiments, the second network node 206 can provide a second cell over the second geographical area 208. The second cell can fully or partially overlap the first cell such that the first network node 202 and the second network node 206 cover an overlapping geographical area. In other embodiments, the first network node 202 can provide a first cell and the second network node 206 can provide a second cell. The coverage area of the first cell can be distinct from the coverage area of the second cell. In other words, the first cell provided by the first network node 202 does not overlap with the second cell provided by the second network node 206. The first cell can be within a proximity to the second cell to enable interference between the first cell and the second cell.

As illustrated, the Xn proxy 210 is situated in the second geographical area. However, it should be appreciated that in real world scenarios, the Xn proxy 210 can be physically integrated with the second network node 206, or physically apart from the second network node 206. The Xn proxy 210 can be situated inside or outside of the second geographical area 208.

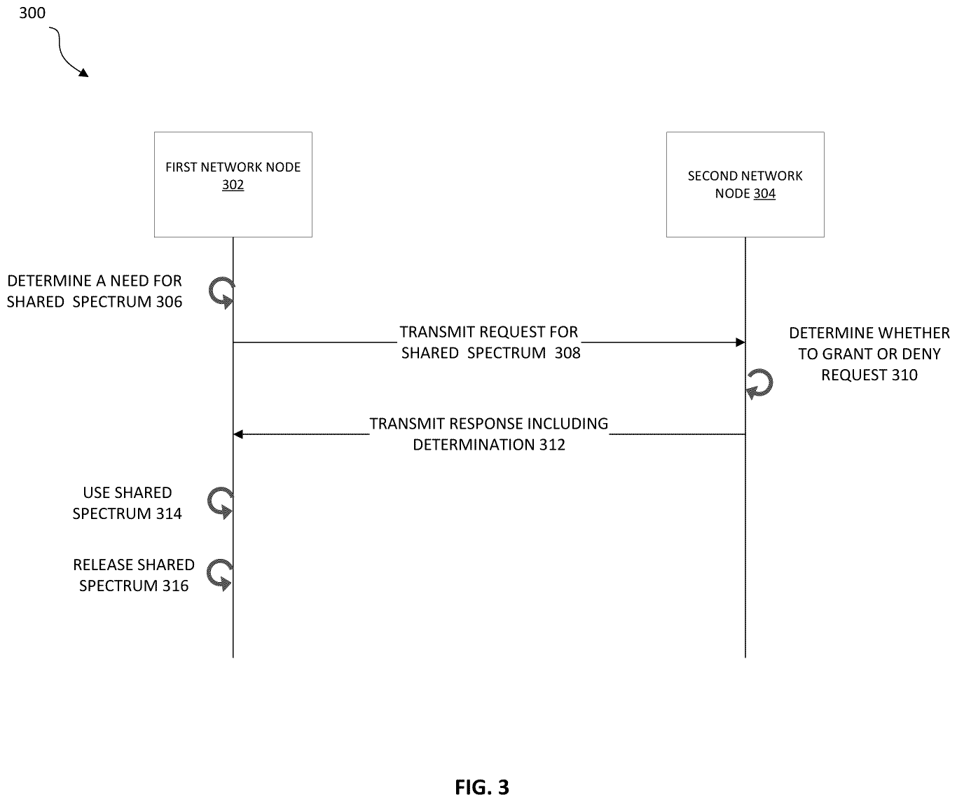

Furthermore, as described herein, communications between a first network node and an Xn proxy can be considered to be communication between the first network node 202 and the second network node 206. For example, the Xn proxy 210 can receive a communication from the first network node 202, translate the communication, and transmit it to the second network node 206. The second network node 206 can transmit a response to the Xn proxy 210. The Xn proxy 210 can translate the response and transmit the response to the first network node 202. Furthermore, as described below, either the first network node or the second network node can be the network node that is operated by a non-3GPP entity. Therefore, although FIGS. 3-8 do not include an Xn proxy, it should be appreciated that an Xn proxy could be incorporated into any of the Figures.

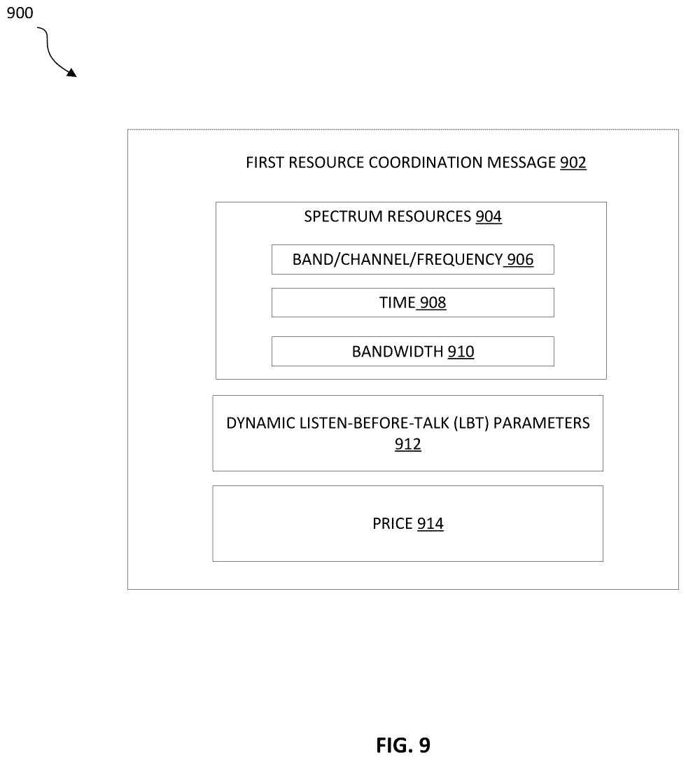

FIGS. 3-8 describe messages that are transmitted between a first network node and a second network node. A message between the first network node and the second network node can be referred to as a resource coordination message. These messages can be exchanged between the first network node and the second network node via an Xn or another interface. The messages are described with more detail with respect to FIG. 9.

FIG. 3 is a signaling diagram 300 for a first network node in communication with a second network node for spectrum sharing coordination, according to one or more embodiments. As illustrated, a first network node 302 can be in communication with a second network node 304 via an Xn or similar interface. The first network node 302 and the second network node 304 can respectively be associated with operators belonging to the same tier.

Furthermore, both the first network node 302 and the second network node 304 can be configured with information regarding which shared spectrum resources, in the time domain and the frequency domain, that each node can use. For example, the first network node 302 can be configured by a core network (CN). The CN can include an access and mobility function (AMF). The first network node 302 can communicate with the AMF via an NG interface (NG). The NG connects the first network node 302 to the CN. A control plane of the NG permits signaling between the first network node 302 and the AMF. The user plane of the NG permits the transfer of application data between the first network node 302 and the AMF. The second network node 304 can be configured similarly to the first network node 302.

At 306, the first network node 302 can determine a need to use shared spectrum. The determination can be based on various parameters, such as a number of user equipment (UEs) in communication with the first network node 302, predictive algorithms, or other appropriate parameters. At 308, the first network node 302 can transmit a request for shared spectrum to the second network node 304. The request can include requested spectrum resources such as band, channel, or frequency. The request can further include a requested time of use for the shared spectrum. The request can further include a requested bandwidth (e.g., in granularity of MHz chunks, or a list of resource blocks (RB s)). At 310, the second network node 304 can determine whether to grant or deny the request. The determination can be based on, for example, the second network nodes own demands. At 312, the second network node 304 can transmit a response to the first network node 302. The response can include a grant or a denial of the request. The response can include a partial or full grant of the request. If the response is a grant, the response can further include the terms of the grant, such as a time of use and bandwidth. At 314, the first network node 302 can use, if granted, the shared spectrum. At 316, the first network node 302 can release the shared spectrum based on various parameters. For example, the first network node 302 can release the shared spectrum based on the expiration of time of use associated with the grant. The first network node 302 can also release the shared spectrum based on no longer using the shared spectrum before the expiration of the time of use associated with the grant. The first network node 302 can return (e.g., release from using) the shared spectrum to the second network node 304 explicitly by transmitting a message, or implicitly without signaling.

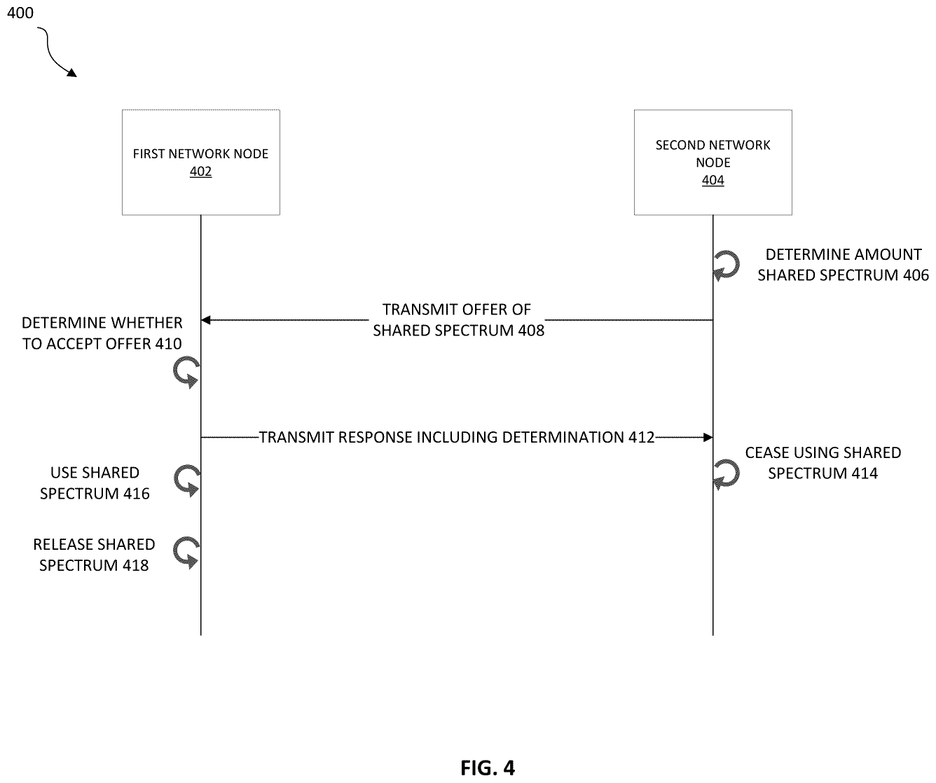

FIG. 4 is a signaling diagram 400 for a first network node in communication with a second network node for spectrum sharing coordination, according to one or more embodiments. As illustrated, a first network node 402 can be in communication with a second network node 404 via an Xn or similar interface. The first network node 402 and the second network node 404 can respectively be associated with operators belonging to the same tier. Furthermore, both the first network node 402 and the second network node 404 can be configured with information regarding which shared spectrum resources, in the time domain and the frequency domain, that each node can use.

At 406, the second network node can determine an amount of available shared spectrum. In particular, the second network node 404 can determine whether it has excess shared spectrum. If there is excess shared spectrum, the second network node 404 can transmit a message, including an offer to provide shared spectrum to the first network node 402, at 408. The offer can include which resources are being offered and for what time period. At 410, the first network node 402 can determine whether to accept or deny the offer. For example, the first network node 402 can determine whether it intends to use the shared spectrum. At 412, the first network node 402 can transmit a response including the determination to the second network node 404. The response can include a partial or full acceptance of the offer. The response can include a requested time for the use of the shared spectrum. The request can further include a requested bandwidth. If the offer is accepted, the second network node 404 can cease to use any of the accepted resources if any of the resources are being used at 414. If the offer is denied, the second network node 404 can continue to use any resources it is using. At 416, the first network node 402 can use the shared spectrum. At 418, the first network node can release the shared spectrum. For example, the first network node 402 can release the shared spectrum based on the expiration of the time of use associated with the offer. The first network node 402 can also release the shared spectrum based on no longer using the shared spectrum before the expiration of the time of use associated with the offer. The first network node 402 can also release the shared spectrum based on the second network node 404 requesting the shared spectrum back, and before the expiration of the time of use associated with the offer. The first network node 402 can release the shared spectrum to the second network node 404 explicitly by transmitting a message, or implicitly without signaling.

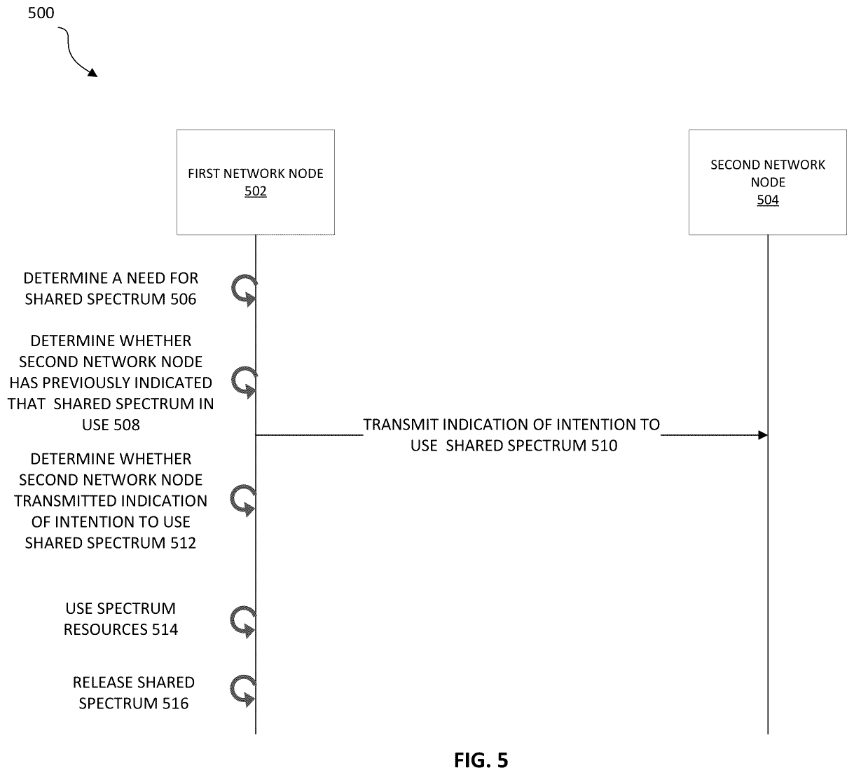

FIG. 5 is a signaling diagram 500 for a first network node in communication with a second network node for spectrum sharing coordination, according to one or more embodiments. As illustrated, a first network node 502 can be in communication with a second network node 504 via an Xn or similar interface. The first network node 502 and the second network node 504 can respectively be associated with operators belonging to the same tier. In this embodiment, the first network node 502 and the second network node 504 are not assumed to be configured with information regarding which shared spectrum resources, in the time domain and the frequency domain, that each node can use. Each network node can assume that the entire shared spectrum is available, unless indicated otherwise by other neighbor nodes. This embodiment can be viewed as listen-before-talk (LBT) over a network interface. LBT is a technique that can be used in communications whereby the first network node 502 and the second network node 504 can first sense the radio environment before it starts a transmission. LBT can be used by the first network node 502 and the second network node 504 to find shared spectrum that the node is allowed to operate on.

At 506, the first network node 502 can determine an intent to use for shared spectrum. At 508 the first network node 502 can determine whether the second network node 504 (e.g., a neighbor node) had previously indicated that the shared spectrum is in use. For example, the first network node 502 can determine whether a band, channel, frequency, time, or bandwidth has previously been indicated for use by a neighbor (e.g., the second network node 504). If the second network node 504 has not indicated the intent to use of the shared spectrum, the first network node 502 can transmit a message including the intention to use the shared spectrum at 510. The message can include which resources, in the time and frequency domain. At 512, the first network node 502 can determine whether the second network node 504 transmitted an indication of intention to use the shared spectrum. The determination can be based on an expiration of time between transmitting the message at step 510 and a threshold time period. If the threshold time period expires, the first network node 502 can assume that there is no collision and that the second network node 504 did not transmit a message, similar to step 510 message, to the first network node 502. The first network node can further assume that it can use the shared spectrum as indicated in the message at step 510. At 512, the first network node 502 can use the shared spectrum. At 514, the first network node 502 can release the shared spectrum based on the expiration of the time indicated in the message at step 510. The shared spectrum is assumed to be available for use by other nodes at the expiration of the time.

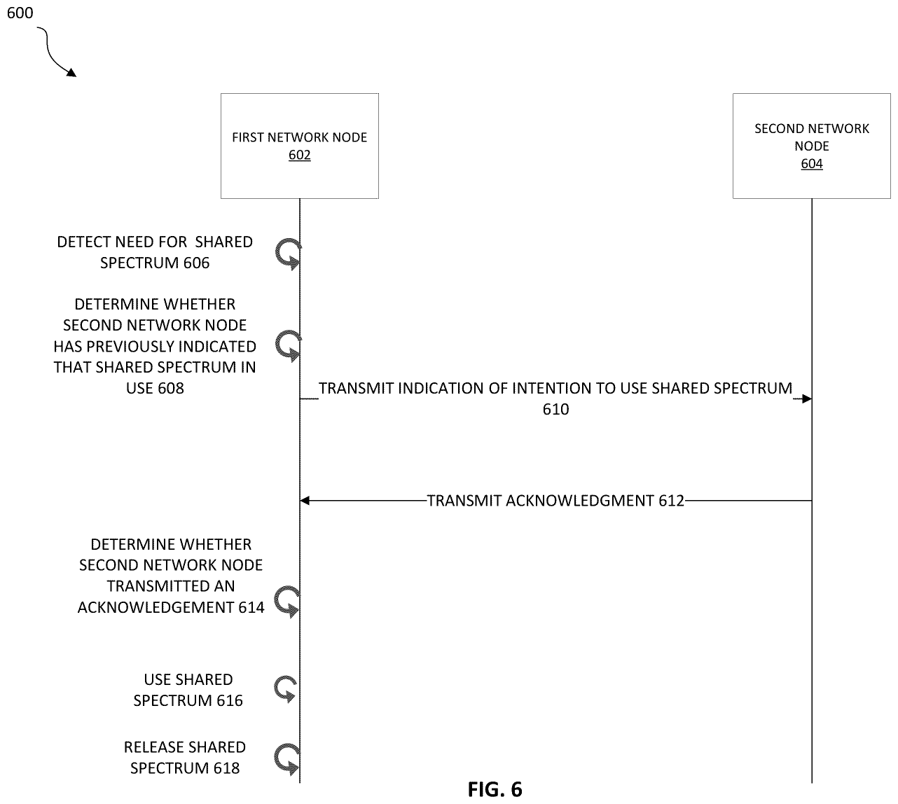

FIG. 6 is a signaling diagram 600 for a first network node in communication with a second network node for spectrum sharing coordination, according to one or more embodiments. As illustrated, a first network node 602 can be in communication with a second network node 604 via an Xn or similar interface. The first network node 602 and the second network node 604 can respectively be associated with operators belonging to the same tier. In this embodiment, the first network node 602 and the second network node 604 are not assumed to be configured with information regarding which shared spectrum resources, in the time domain and the frequency domain, that each node can use. Each network node can assume that the entire shared spectrum is available, unless indicated otherwise by other neighbor nodes. This embodiment can be viewed as LBT over a network interface.

At 606, the first network node 602 can determine a need to use shared spectrum. If the node determines a need to use shared spectrum, the first network node 602 can determine whether the second network node 604 (e.g., a neighbor node) had previously indicated that the shared spectrum is in use at 608. For example, first network node 602 can determine whether a band, channel, frequency, time, or bandwidth has previously been indicated for use by a neighbor (e.g., the second network node 604). If the second network node 604 has not indicated use of the shared spectrum, the first network node 602 can transmit a message intention to use the shared spectrum, at 610. The message can include which resources, in the time and frequency domain. At 612, the second network node 604 can transmit an acknowledgment. The second network node 604 transmits the acknowledgment if the second network node 604 is not using the shared spectrum or does not intend to use the shared spectrum during a time of use indicated by the message of step 610.

At 614, the first network node 602 can determine whether the second network node 604 transmitted an acknowledgment. The determination can be based on an expiration of time between transmitting the message at step 610 and a threshold time period. If the threshold time period expires, the first network node 602 can assume that the second network node 604 does not intend to send an acknowledgment, and therefore the first network node 602 cannot use the shared spectrum. If an acknowledgment is received before the expiration of the threshold time, the first network node 602 can assume that it can use the shared spectrum. If there are multiple neighbors, the first network node 602 waits for all the neighbors to respond with an acknowledgment. At 616, the first network node 602 can use the shared spectrum for the indicated period of time from the message at step 610. Alternatively, the acknowledgment can provide a fixed period of time. At 618, the first network node 602 can release the shared spectrum based on expiration of the time indicated in the message at step 610. The shared spectrum is assumed to be available for use by other nodes at the expiration of the time.

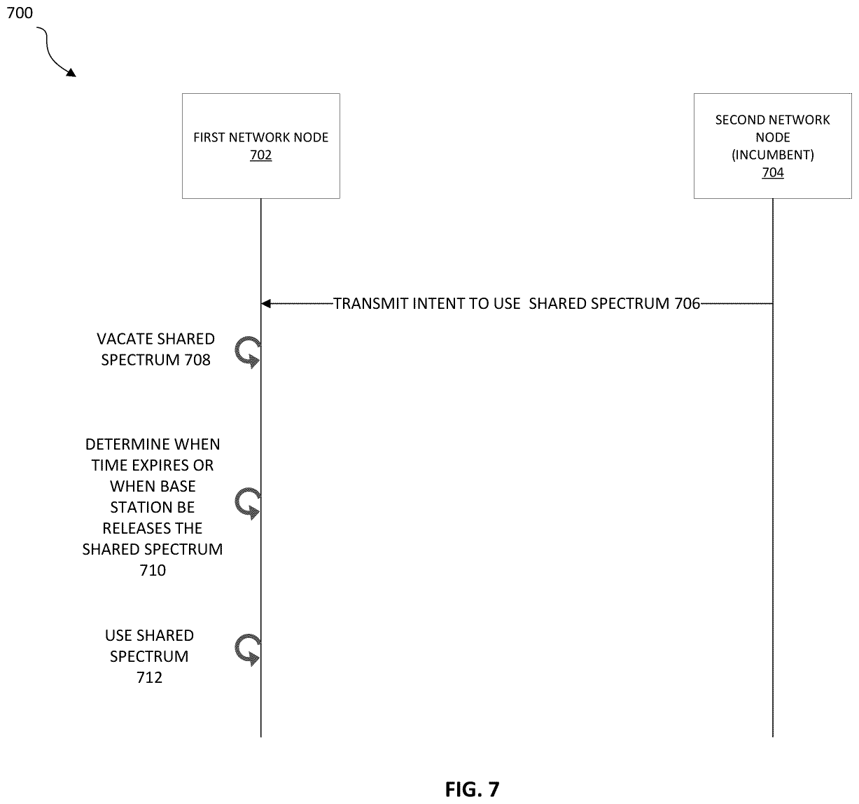

FIG. 7 is a signaling diagram 700 for a first network node in communication with a second network node for spectrum sharing coordination, according to one or more embodiments. As illustrated, a first network node 702 can be in communication with a second network node 704 via an Xn or similar interface. The first network node 702 and the second network node 704 can respectively be associated with operators belonging to different tiers, where the second network node 704 belongs to a higher tiered operator (e.g., incumbent tier). The first network node 702 assumes that it can use the shared spectrum unless the second network node indicates otherwise.

At 706, the second network node 704 can transmit a message including an intention to use shared spectrum. The message can include parameters such as a time of use, band, channel, frequency, time, or bandwidth. At 708, if the first network node 702 is using the shared spectrum described by the message parameters, the node can release the shared spectrum. At 710, the first network node 702 can determine if the time of use has expired or if the second network node 704 has released the shared spectrum. If the time of use has expired or the second network node 704 has released the shared spectrum, the first network node, can use the shared spectrum, at 712.

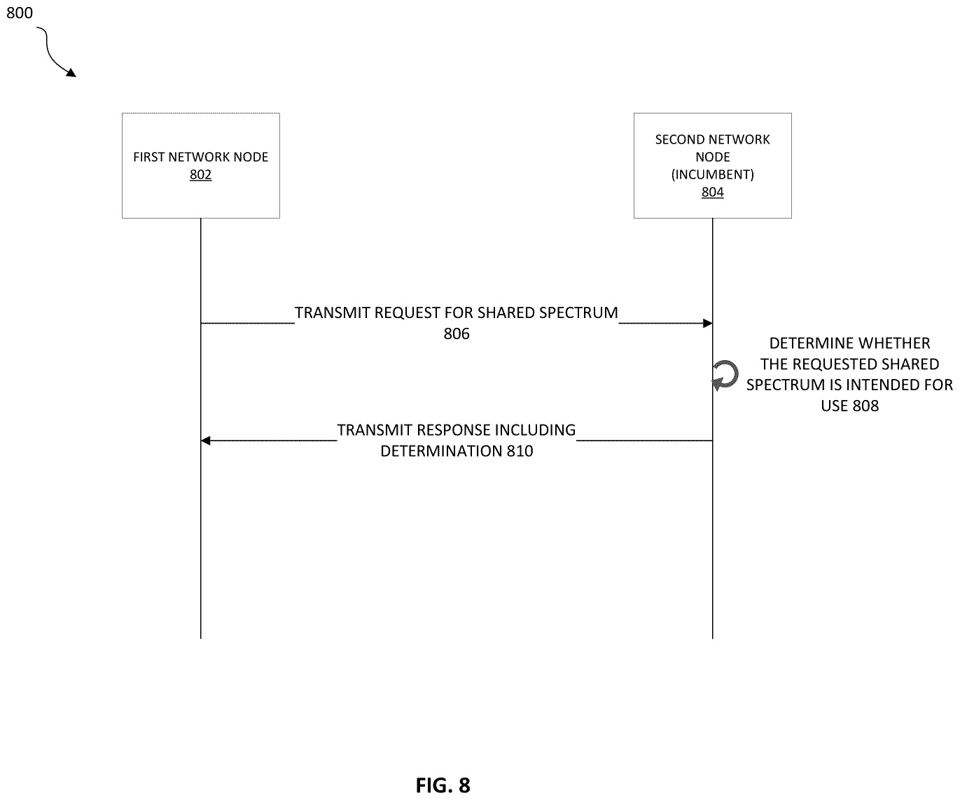

FIG. 8 is a signaling diagram 800 for a first network node in communication with a second network node for spectrum sharing coordination, according to one or more embodiments. As illustrated, a first network node 802 can be in communication with a second network node 804 via an Xn or similar interface. The first network node 802 and the second network node 804 can respectively be associated with operators belonging to different tiers, where the second network node 804 belongs to a higher tiered operator (e.g., incumbent tier).

At 806, the first network node 802 can transmit a message including a request for shared spectrum to the second network node 804. The message can include parameters such as a time of use, band, channel, frequency, time, or bandwidth. At 806, the second network node 804 can determine whether the requested shared spectrum is intended for use by the second network node 804. At 810, the second network node 804 can transmit a message including an acknowledgment, if the second network node 804 does not intend to use by the second network node 804. The first network node 802 can assume that it can use the shared spectrum based on the acknowledgment.

FIG. 9 is an illustration 900 describing a resource coordination message 902, according to one or more embodiments. The resource coordination message 902 can be a previously undefined message, or the resource coordination message can be an extension of a message as defined by 3GPP TS 38.423 V17.0.0 (2022-04). The resource coordination message 902 includes one or more information elements (IEs) to be relayed to and from the first network node and the second network node. For example, the resource coordination message 902 can be used as a message, to convey an offer, to transmit a response, to convey an acknowledgment, or other communication between the first network node and the second network node.

The resource coordination message 902 can include an IE for spectrum resources 904, which include IEs for band, channel, or frequency 906, time 908, or bandwidth 910. The IEs can further include dynamic LBT parameters 912 and an IE for price 914. Each of the IEs can convey information based on whether the message is a request, intention, or offer; or whether the message is a response to a request, intention, or offer. For example, if the message is a request, intention, or offer, the frequency 906, time 908, and bandwidth 910 can be a requested frequency, time (ms), or bandwidth (e.g., in granularity of MHz chunks, or a list of RBs) of the shared spectrum. The dynamic LBT parameters can be carrier-sensing thresholds, in case a new radio unlicensed (NR-U) like channel mechanism is used. If the message is a request, intention, or offer, the price 914 can be a requested price for using the shared spectrum. This is in case spectrum sharing prices have not been negotiated. If the message is a response to a request, intention, or offer, the frequency 906, time 908, and bandwidth 910 can be available frequency, time, or bandwidth of the shared spectrum. If the message is a response to a request, intention, or offer, the price 914 can be an available price for using the shared spectrum.

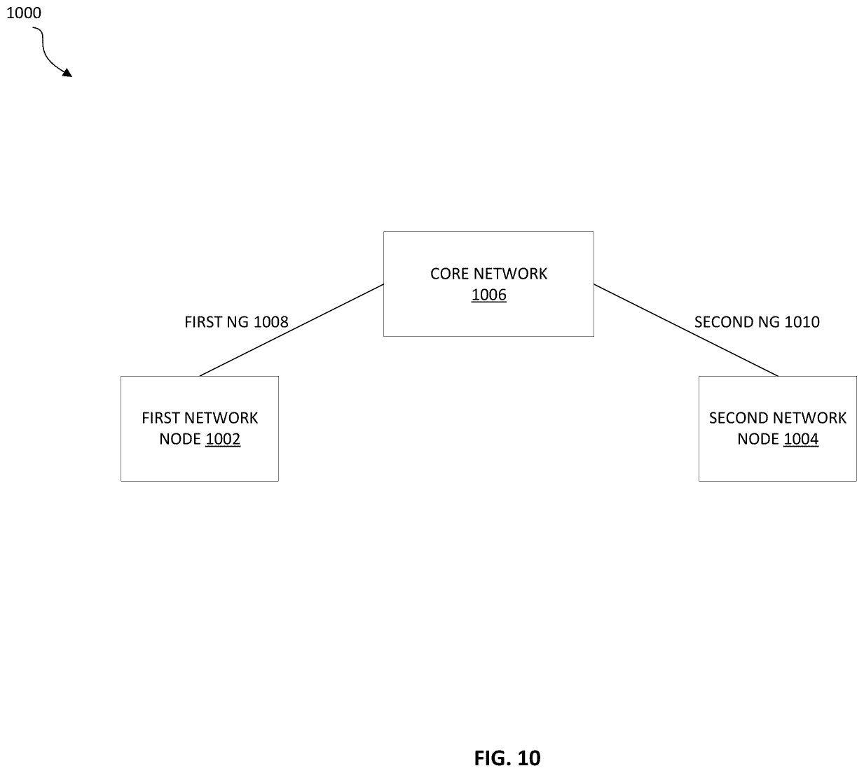

FIG. 10 is an illustration of a resource coordination environment 1000, in which a central network node is used for resource coordination, according to one or more embodiments. As illustrated, a first network node 1002 can be in communication with a second network node 1004 via a core network 1006. The first network node 1002 can communicate with the core network 1006 via a first NG 1008. The second network node 1004 can communicate with the core network via a second NG 1010. As illustrated a first NG 1008 and a second NG 1010 are illustrated, any other interface between a RAN node and the core network 1006 can be used. Each of the above-referenced embodiments (e.g., FIGS. 3-8) can be realized without transmitting resource coordination messages via a Xn or similar interface between the first network node 1002 and the second network node 1004. In the scenario described by FIG. 10, the messages can be exchanged via the core network 1006 (e.g., via an NG application protocol (NG-AP) interface or equivalent interface. There are various ways to implement the architecture described by FIG. 10 to effectuate the spectrum sharing. One option is for a single message (including uplink (UL) and downlink (DL) variants) can be used. The message can encapsulate the information (e.g., IEs) for the messages defined for Xn as a transparent container. Alternatively, another option is for each message, there is a counterpart (including UL and DL variants) message defined at the NG interface. Another alternative is a combination of the two options described above. Either of the first network node 1002 or the second network node 1004 can be connected to the core network directly or via a proxy.

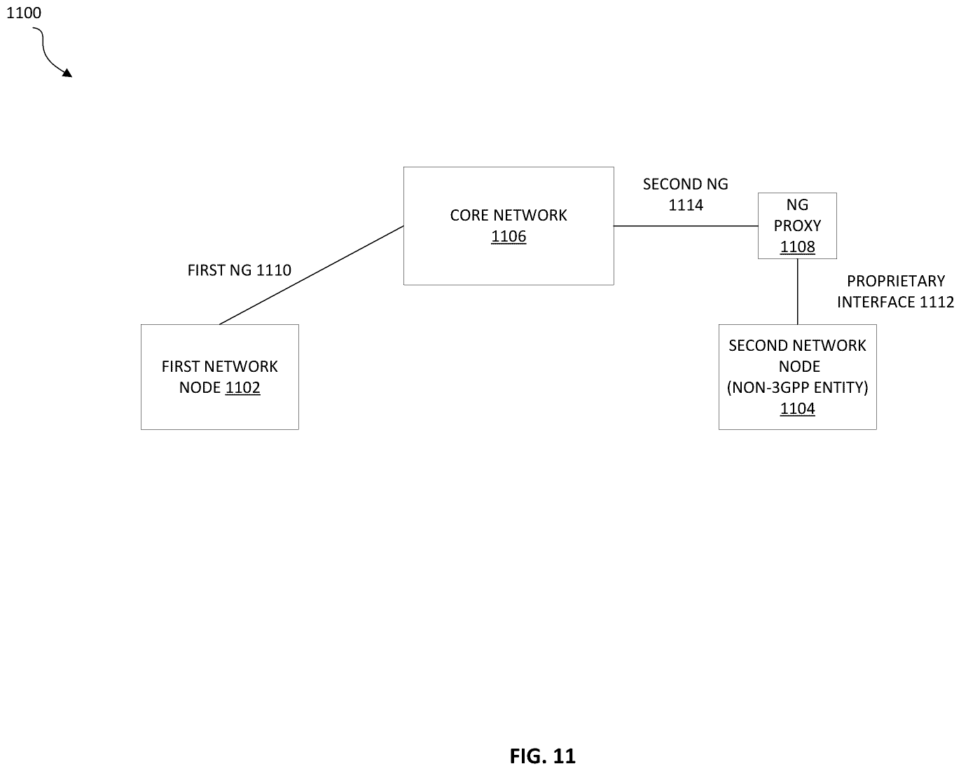

FIG. 11 is an illustration of a resource coordination environment 1100 in which a central network node is used for resource coordination, according to one or more embodiments. As illustrated, a first network node 1102 can be in communication with a second network node 1104 via a core network 1106. The first network node 1102 can communicate with the core network 1106 via a first NG 1110. The second network node 1104 can be operated by a non-3GPP entity and communicate with the core network 1106 an NG proxy 1108 that is in a communication path between the core network 1106 and the second network node 1104. The second network node can communicate with the NG proxy 1108 via a proprietary interface 1112. The NG proxy 1108 can communicate with the core network 1106 via a second NG 1114. As illustrated a first NG 1110 and a second NG 1114 are illustrated, any other interface between a RAN node and the core network 1006 can be used. Each of the above-referenced embodiments (e.g., FIGS. 3-8) can be realized without transmitting resource coordination messages via a Xn or similar interface between the first network node 1102 and the second network node 1104.

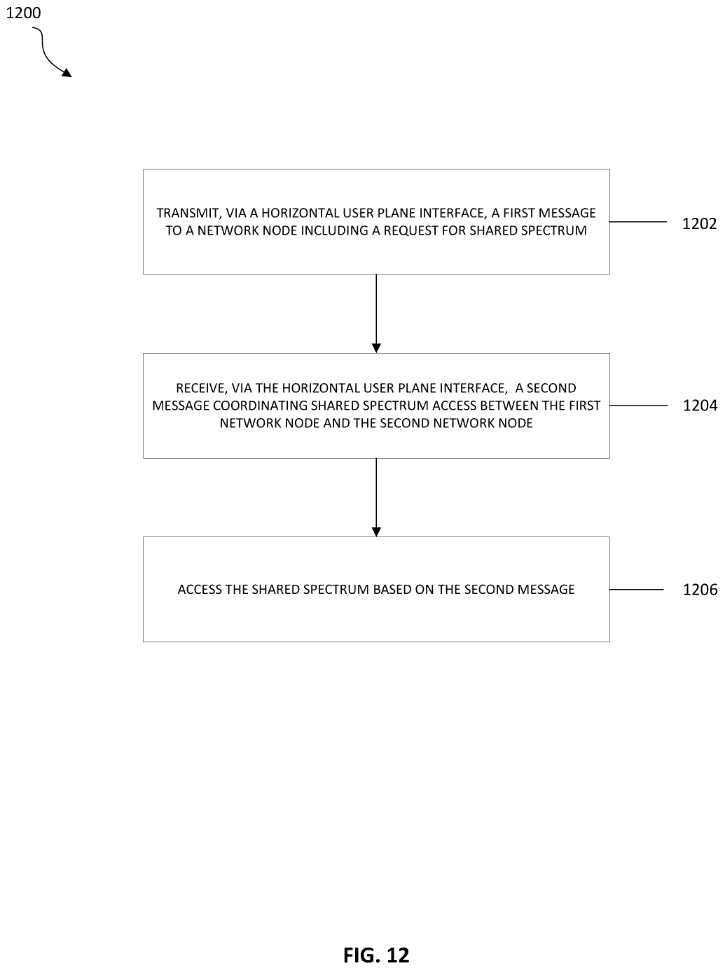

FIG. 12 is a process flow 1200 for spectrum sharing without network sharing, according to one or more embodiments. At 1202, a first network node can transmit, via a horizontal user plane interface (e.g., Xn), a first message to a second network node. The message can include a request for shared spectrum. The first network node being configured to transmit a first network identifier associated with a first operator. The second network node can be configured to transmit a second network identifier associated with a second operator. In some embodiments, the first network node and the second network node can provide fully or partially overlapping cells of a cellular network. In other embodiments, the first network node can provide a first cell and the second network node can provide a second cell. The coverage area of the first cell can be distinct from the coverage area of the second cell. The first cell can be within a proximity to the second cell to enable interference between the first cell and the second cell.

At 1204, the first network node can receive, via the horizontal user plane interface, a second message from the second network node. The second message coordinating shared spectrum access between the first network node and the second network node. In particular, the second message can include available shared spectrum for the first network node. At 1206, the first network node can access the shared spectrum based on the second message

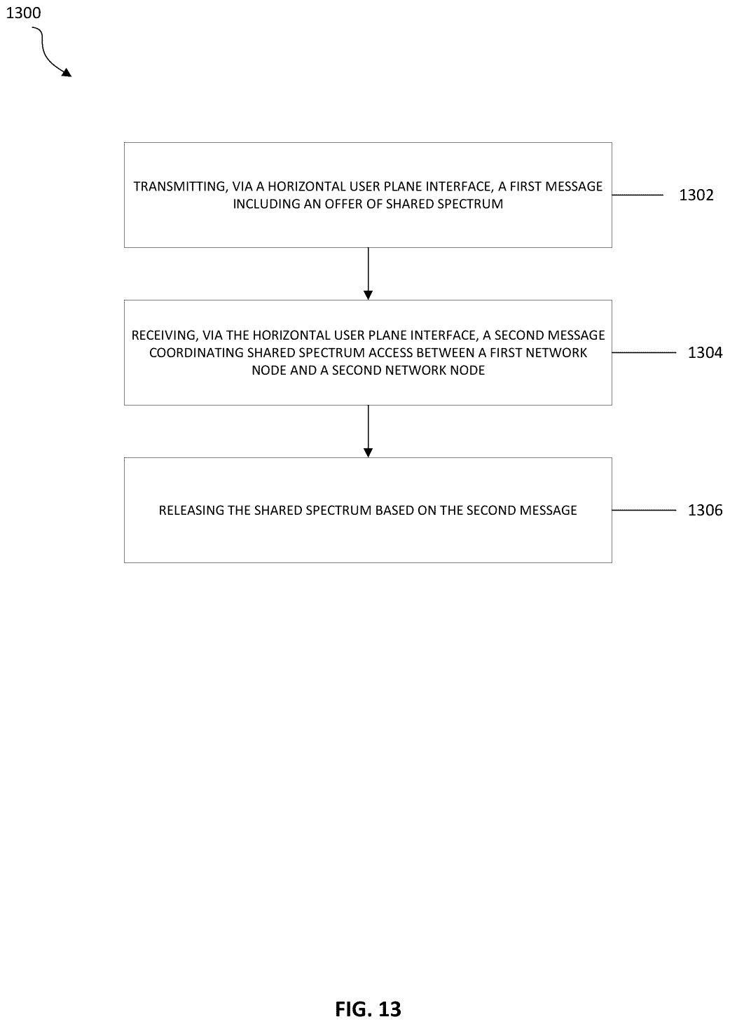

FIG. 13 is a process flow 1300 for spectrum sharing without network sharing, according to one or more embodiments. At 1302, a first network node can receive, via an interface, a first message from a second network node. The first message that includes an intention to use shared spectrum. The first network node being configured to transmit a first network identifier associated with a first operator. The second network node being configured to transmit a second network identifier associated with a second operator.

At 1304, the first network node can determine whether the second network node has released the shared spectrum based on the first message. At 1306, the first network node can access the shared spectrum based on the determination.

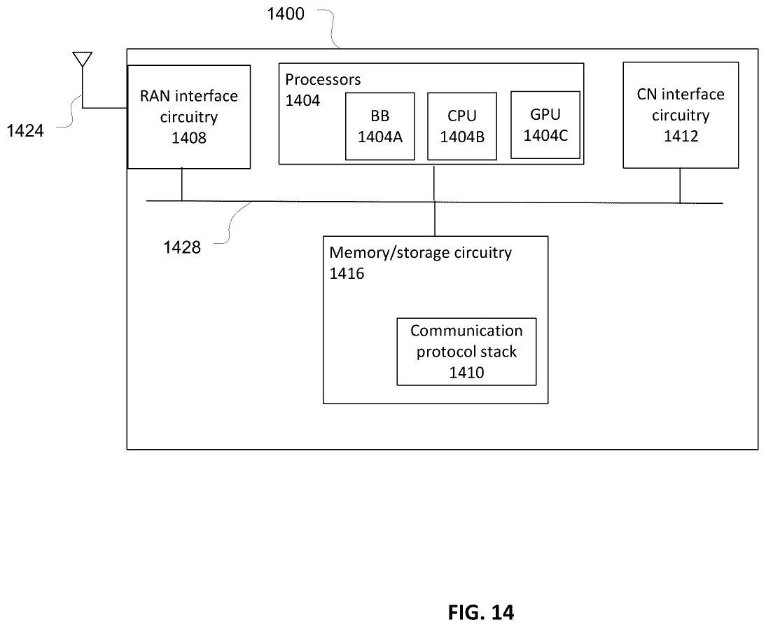

FIG. 14 illustrates a base station 1400, in accordance with some embodiments. The base station 1400 may be similar to and substantially interchangeable with the first or second network nodes described herein.

The base station 1400 may include processors 1404, RF interface circuitry 1408, core network (CN) interface circuitry 1412, and memory/storage circuitry 1416.

The components of the base station 1400 may be coupled with various other components over one or more interconnects 1428.

The processors 1404, RF interface circuitry 1408, memory/storage circuitry 1416 (including communication protocol stack 1410), antenna 1424, and interconnects 1428 may be similar to like-named elements shown and described with respect to FIG. 14.

The CN interface circuitry 1412 may provide connectivity to a core network, for example, a 5^{th} Generation Core network (5GC) using a 5GC-compatible network interface protocol, such as carrier Ethernet protocols, or some other suitable protocol. Network connectivity may be provided to/from the base station 1400 via a fiber optic or wireless backhaul. The CN interface circuitry 1412 may include one or more dedicated processors or FPGAs to communicate using one or more of the aforementioned protocols. In some implementations, the CN interface circuitry 1412 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method, comprising transmitting, by a first network node and via a horizontal interface, a first message to a second network node, the first message including a request for shared spectrum, the first network node being configured to transmit a first network identifier associated with a first operator, the second network node being configured to transmit a second network identifier associated with a second operator; receiving, by the first network node and via the horizontal interface, a second message from the second network node, the second message for coordinating shared spectrum access between the first network node and the second network node; and accessing, by the first network node, the shared spectrum, based on the second message.

Example 2 includes the method of example 1, wherein the first network node is to provide a first cell, the second network node is to provide a second cell, and the first cell fully or partially overlaps the second cell.

Example 3 includes the method of example 1, wherein the first network node is to provide a first cell, the second network node is to provide a second cell, a coverage area of the first cell being distinct from a coverage area of the second cell, the first cell being within a proximity to the second cell to enable interference between the first cell and the second cell.

Example 4 includes the method of any of examples 1-3, wherein the horizontal interface is an Xn interface.

Example 5 includes the method of any of examples 1-4, wherein the first network node transmits network the first message to the second network node via the horizontal interface and an Xn proxy, wherein the Xn proxy is in a communication path between the first network node and the second network node.

Example 6 includes a system comprising means to perform one or more elements of a method described in or related to examples 1-5.

Example 7 includes a non-transitory computer-readable media comprising instructions to cause a network, upon execution of the instructions by one or more processors of the network, to perform one or more elements of a method described in or related to any of examples 1-5.

Example 8 includes a method, comprising transmitting, by a first network node of a first operator and via a horizontal interface, a first message including an offer of shared spectrum to a second network node of a second operator; receiving, by the first network node and via the horizontal interface, a second message, the second message for coordinating shared spectrum access between the first network node and the second network node; and releasing, by the first network node, the shared spectrum based on the second message.

Example 9 includes the method of example 8, wherein the first network node is to provide a first cell, the second network node is to provide a second cell, and the first cell fully or partially overlaps the second cell.

Example 10 includes the method of example 8, wherein the first network node is to provide a first cell, the second network node is to provide a second cell, a coverage area of the first cell being distinct from a coverage area of the second cell, the first cell being within a proximity to the second cell to enable interference between the first cell and the second cell.

Example 11 includes the method of any of examples 8-10, wherein the interface is an Xn interface.

Example 12 includes the method of any of examples 8-11, wherein the first network node and the second network nodes are nodes of a tiered network framework, wherein the first network node has a same tier as the second network node.

Example 13 includes the method of any of examples 8-12, comprising receiving, by a first network node of a first operator and via an interface, a first message from a second network node of a second operator, a first message including an intention to use shared spectrum; determining, by the first network node, whether the second network node has released the shared spectrum based on the first message; and accessing, by the first network node, the shared spectrum based on the determination.

Example 14 includes the method of any of examples 8-13, wherein the first network node and the second network nodes are nodes of a tiered network framework, and wherein the second network node has a higher tier than the first network node.

Example 15 includes the method of any of examples 8-14, wherein the first network node is to provide a first cell, the second network node is to provide a second cell, and the first cell fully or partially overlaps the second cell.

Example 16 includes the method of any of examples 8-15, wherein the first network node is to provide a first cell, the second network node is to provide a second cell, a coverage area of the first cell being distinct from a coverage area of the second cell, the first cell being within a proximity to the second cell to enable interference between the first cell and the second cell.

Example 17 includes the method of any of examples 8-16, wherein the determination is based on receiving the second message from the second network node within a threshold time interval.

Example 18 includes the method of any of examples 8-17, wherein the interface is an Xn interface

Example 19 includes a system comprising means to perform one or more elements of a method described in or related to examples 8-18.

Example 20 includes a non-transitory computer-readable media comprising instructions to cause a network, upon execution of the instructions by one or more processors of the network, to perform one or more elements of a method described in or related to any of examples 8-18.

Example 21 includes a method, comprising transmitting, by a first network node of a first operator and via a next generation (NG) interface, a first message to a second network node of a second operator, the message including a request for shared spectrum; receiving, by the first network node and via the NG interface, a second message from the second network node, the second message for coordinating shared spectrum access between the first network node and the second network node; and accessing, by the first network node, the shared spectrum, based on the second message.

Example 22 includes the method of example 21, wherein the first network node transmits the first message to the second network node via a core network, and wherein the method further comprises transmitting the first message to an access and mobility function (AMF) of the core network via a next generation interface (NG).

Example 23 includes the method of any of examples 21 and 22, wherein the method further comprises receiving the second message from the AMF of the core network.

Example 24 includes the method of any of examples 21-23, wherein the first network node transmits network the first message to the second network node via the horizontal interface and an NG proxy, wherein the NG proxy is in a communication path between the core network and the second network node.

Example 25 includes a system comprising means to perform one or more elements of a method described in or related to examples 21-24.

Example 26 includes a non-transitory computer-readable media comprising instructions to cause a network, upon execution of the instructions by one or more processors of the network, to perform one or more elements of a method described in or related to any of examples 21-24.

Example 27 includes A method comprising transmitting, by a first base station to a second base station, a first message comprising a request for shared spectrum, the first base station being associated with a first operator, the second base station being associated with a second operator, the first base station transmitting the first message via an Xn interface used for communication between the first base station and the second base station; receiving, by the first base station, a second message from the second base station, the second message for coordinating shared spectrum access between the first base station and the second base station; and accessing, by the first base station, the shared spectrum, based on a coordination, with the second base station, for shared spectrum via the Xn interface.

Example 28 includes the method of example 27, wherein the shared spectrum is provided by a Citizen's Broadband Radio Service (CBRS), wherein the first operator and the second operator are associated with the CBRS, and wherein the second operator is a higher tier user of the CBRS than the first operator.

Example 29 includes the method of any of examples 27 and 28, wherein the first message comprises a requested shared spectrum frequency, a requested time of use of the shared spectrum, or a requested shared spectrum bandwidth.

Example 30 includes the method of any of examples 27-29, wherein the second message comprises a time period for using the shared spectrum, and wherein the method further comprises: using the shared spectrum during a portion of the time period; and releasing the shared spectrum, prior to expiration of the time period back to the second base station based no longer using the shared spectrum during the time period.

Example 31 includes the method of any of examples 27-30, wherein the first base station provides coverage for first cell of the first operator, wherein the second base station provides a coverage of a second cell of the second operator, and wherein the first cell overlaps the second cell.

Example 32 includes the method of any of examples 27-31, wherein the first base station receives the second message using the Xn interface.

Example 33 includes the method of any of examples 27-31, wherein the second message comprises a partial grant of the request for the shared spectrum, and wherein the second message further comprises terms for using a shared spectrum frequency, a requested time of use of the shared spectrum, or a requested shared spectrum bandwidth based on the partial grant of the request for shared spectrum.

Example 34 includes a system comprising means to perform one or more elements of a method described in or related to examples 27-33.

Example 35 includes a non-transitory computer-readable media comprising instructions to cause a network, upon execution of the instructions by one or more processors of the network, to perform one or more elements of a method described in or related to any of examples 27-33.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
transmitting, by a first base station to a second base station, a first message comprising a request for shared spectrum, the first base station being associated with a first operator, the second base station being associated with a second operator, the first base station transmitting the first message via an Xn interface used for communication between the first base station and the second base station;
receiving, by the first base station, a second message from the second base station, the second message for coordinating shared spectrum access between the first base station and the second base station; and
accessing, by the first base station, the shared spectrum, based on a coordination, with the second base station, for shared spectrum via the Xn interface.

2. The method of claim 1, wherein the shared spectrum is provided by a Citizen's Broadband Radio Service (CBRS), wherein the first operator and the second operator are associated with the CBRS, and wherein the second operator is a higher tier user of the CBRS than the first operator.

3. The method of claim 1, wherein the first message comprises a requested shared spectrum frequency, a requested time of use of the shared spectrum, or a requested shared spectrum bandwidth.

4. The method of claim 1, wherein the second message comprises a time period for using the shared spectrum, and wherein the method further comprises:
using the shared spectrum during a portion of the time period; and
releasing the shared spectrum, prior to expiration of the time period back to the second base station based no longer using the shared spectrum during the time period.

5. The method claim 1, wherein the first base station provides coverage for first cell of the first operator, wherein the second base station provides a coverage of a second cell of the second operator, and wherein the first cell overlaps the second cell.

6. The method of claim 1, wherein the first base station receives the second message using the Xn interface.

7. The method of claim 1, wherein the second message comprises a partial grant of the request for the shared spectrum, and wherein the second message further comprises terms for using a shared spectrum frequency, a requested time of use of the shared spectrum, or a requested shared spectrum bandwidth based on the partial grant of the request for shared spectrum.

8. A first base station, comprising:
memory;
radio frequency (RF) circuitry; and
processing circuitry, coupled with the memory, to:
determine an amount of available shared spectrum in excess of a need of the first base station;
transmit, to a second base station, a first message comprising terms of an offer of access to the available shared spectrum in excess of the need of the first base station based on the determination of the amount of available spectrum in excess of a need of the first base station, the first base station associated with a first operator and the second base station associate with a second operator; and
receiving, from the second base station, a second message comprising terms of an acceptance of the offer of access to the available shared spectrum.

9. The first base station of claim 8, wherein the first base station transmits the first message to the second base station using an Xn interface.

10. The first base station of claim 8, wherein the first base station provides coverage for first cell of the first operator, wherein the first base station comprises an Xn proxy device arranged within the first cell, wherein the first base station transmits first message to the Xn proxy device using an interface, and wherein the Xn proxy device is configured to communicate with the second base station using an Xn interface.

11. The first base station of claim 8, wherein the first base station transmits the first message to the second base station via a core network using an Ng interface.

12. The first base station of claim 8, wherein the first base station provides coverage for first cell of the first operator, wherein the first base station comprises an Xn proxy device arranged within the first cell, wherein the first base station transmits first message to the Xn proxy device using an interface, wherein Xn proxy device is configured to communicate with a core network using a first Ng interface, and wherein the core network is configured to communicate with the second base station using a second Ng interface.

13. The first base station of claim 8, wherein the terms of the offer comprise an offered shared spectrum frequency, an offered time of use of the shared spectrum, or an offered shared spectrum bandwidth.

14. The first base station of claim 8, wherein the terms of the offer comprise available resources, wherein the terms of the acceptance comprise an acceptance of the available resources, and wherein the processing circuitry, coupled with the memory, further to:
cease using the accepted available resources based on receiving the terms of the acceptance.

15. The first base station of claim 8, wherein the terms of the offer comprise a time period for using the shared spectrum, and wherein the processing circuitry, coupled with the memory, further to:
receive, from the second base station, an indication that the second base station is releasing the shared spectrum prior to expiration of the time period.

16. The first base station of claim 8, wherein the shared spectrum is provided by a Citizen's Broadband Radio Service (CBRS), wherein the first operator and the second operator are associated with the CBRS, and wherein the second operator is a higher tier user of the CBRS than the first operator.

17. One or more non-transitory, computer-readable media including stored thereon instructions that, when executed by one or more processors, cause a first base station to:
determine a need for shared spectrum for use by the first base station;
transmit, a message to a second base station, a first message indicating an intention to use the shared spectrum based on the determined need for the shared spectrum, the first base station associated with a first operator and the second base station associate with a second operator;
determine that the second base station has not indicated an intention to use the shared spectrum; and
access the shared spectrum, based on the determination that the that the second base station has not indicated an intention to use the shared spectrum.

18. The one or more non-transitory, computer-readable media of claim 17, wherein determining that the second base station has not indicated an intention to use the shared spectrum comprises:
determining that the second base station has not transmitted a second message to the first base station indicating an intention to use the shared spectrum.

19. The one or more non-transitory, computer-readable media of claim 17, wherein the instructions that, when executed by one or more processors, further cause the first base station to transmit the first message to the second base station via an Xn interface.

20. The one or more non-transitory, computer-readable media of claim 17, wherein the shared spectrum is provided by a Citizen's Broadband Radio Service (CBRS), wherein the first operator and the second operator are associated with the CBRS, and wherein the second operator is a higher tier user of the CBRS than the first operator.
